(19) United States
(12) Patent Application Publication
(10) Pub. No.: US 2009/0093990 A1
(43) Pub. Date: Apr. 9, 2009

(54) MOBILE BODY MAPPING AND MATTRESS TESTING

(76) Inventors: Daniel J. McGuire, Sugarland, TX (US); Michael A. Mettler, Sealy, TX (US); Robert S. Stagner, Houston, TX (US)

Correspondence Address: HAYNES AND BOONE, LLP;IP Section, 2323 Victory Avenue, Suite 700, Dallas, TX, 75219, US

(21) Appl. No.: 11/868,062

(22) Filed: Oct. 5, 2007

(51) Int. Cl. G01L 1/00

(52) U.S. Cl. 702/139

(57) ABSTRACT

An exemplary mobile mattress sensor system is described, the system includes a pressure sensing pad and a computer device having an associated display operable to receive signals from the pressure sensing pad and cause the display a body map associated with the received signals. The mobile mapping system further includes a power source for powering the computer device, and a cart for transporting the pressure sensing pad, computer device, and power source. The mobile body mapping system allows a user to transport the mobile body mapping system throughout a store to test and generate body maps for different mattresses. Further, many different mattresses may be uniquely tested for a particular user with a single pressure sensing pad (as opposed to having multiple pressure sensing pads and computing devices for each mattress or a small set of “test” beds including pressure sensing pads and computing devices).

### BACKGROUND

1. Field

The present invention relates generally to a pad of sensors laid on a mattress, and in one particular example, to a mobile sensor system for performing body mapping and testing of different mattresses.

2. Related Art

Selecting and purchasing a mattress can be a difficult and time-consuming process, at least in part, because potential purchasers generally vary physically and have different desires in terms of firmness and comfort. In an attempt to aid in the selection and purchase of a mattress it is known to generate pressure maps of a person's body and select or recommend a particular mattress type or style based on the resulting pressure map. For example, a particular mattress may be well suited for someone with high pressure in the hip area, but not for someone with a more distributed pressure profile.

Several products are known for providing pressure sensing, which may be used to map body pressure of a consumer lying on a mattress. For example, XSENSOR Technology Corporation provides various pressure sensing pads, for example, suitable for use with a bed or mattress. Such pressure sensing pads may be included with a “test” bed for determining a user's body pressure map, the body pressure map useful in selecting or recommending a mattress as described above.

It is desired, however, to map a user's body pressure on different mattresses, including those mattresses the user is interested in buying, at least in part, because the pressure map will generally depend uniquely on both the particular user and the underlying mattress. Further, because mattress stores are often large it is desirable that the mattress pad and associated system be mobile to reduce the cost to the store and accuracy for the user by allowing the ability to generate a pressure map for many different mattresses.

### BRIEF SUMMARY

In one aspect of the present invention, a mobile body mapping system is described for allowing the transportation of a pressure sensing pad and computing device for body mapping a user on a mattress. In one example, a mobile body mapping system includes a pressure sensing pad and a computer device having an associated display operable to receive signals from the pressure sensing pad and cause the display of a body map associated with the received signals. The mobile mapping system further includes a power source for powering the computer device, and a cart for transporting the pressure sensing pad, computer device, and power source. The mobile body mapping system may allow a user to move through a mattress store and generate unique body maps on various mattresses, e.g., allowing a user to transport the mobile body mapping system throughout a mattress store to test and generate body maps for each mattress.

The pressure sensing pad may include a flexible pressure sensing pad suitable for placement with a mattress to generate signals suitable for body mapping as described. In one example, the pressure sensing pad includes a two-dimensional array of capacitance or force sensors. The sensing pad may further include or be associated with an interface unit to provide driving signals to the pressure sensing pad and receive signals therefrom. Additionally, the computing device may include logic (e.g., software) to process received signals and generate graphical displays such as pressure body maps.

The power source may include one or more rechargeable batteries, and the mobile mapping system may further include a battery charger device, power converter device (e.g., DC to AC converters), terminal strips for powering the described or additional devices, and so on. Accordingly, an exemplary mobile device system may be fully contained during use.

In some examples, the mobile mapping system may further include a printer for printing body maps and other related information. Additionally, various devices included with the mobile mapping system may be connected in a wired fashion, e.g., via USB cables or the like, or wirelessly, e.g., via RF signals, a wireless network, or other wireless communication technologies.

In another example, a mobile body mapping system comprises a cart, a computer device operable to receive signals from a pressure sensing pad and cause a display associated with the received signals on a display associated therewith, and a power supply for powering the computer device and display, where the cart supports the computer device and power supply for transportation. The cart may further support the pressure sensing pad during transportation, for example, from one mattress to another.

In another example, a method for body mapping a user comprises placing a pressure sensing pad over a first mattress and receiving signals from the pressure sensing pad at a computing device, and causing the display of an image based on the received signals, where the computing device is included with a mobile mapping apparatus, the apparatus comprising a cart for supporting the computing device, the pressure sensing pad, and a power supply for powering the computing device during transportation. The method further includes removing the pressure sensing pad from the first mattress, transporting the cart to a second location and placing the pressure sensing pad over a second mattress. The method further including selecting a mattress based on body maps associated with the first and second mattresses.

Various examples and aspects of the present invention are better understood upon consideration of the detailed description below in conjunction with the accompanying drawings and claims.

### BRIEF DESCRIPTION OF THE DRAWINGS

FIGS. 1A and 1B illustrate an exemplary mobile mattress sensor system according to one example;

FIG. 2 schematically illustrates an exemplary mobile mattress sensor system according to one example;

FIG. 3 schematically illustrates an exemplary mobile mattress sensor system according to another example; and

FIG. 4 illustrates an exemplary method for generating pressure maps and testing mattresses using a mobile mattress sensor.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments. Various modifications to the examples described will be readily apparent to those of ordinary skill in the art, and the general principles defined may be applied to other examples and applications without departing from the spirit and scope of the invention. Thus, the present invention is not intended to be limited to the examples described herein and shown, but is to be accorded a scope consistent with the claims.

Broadly speaking, and in one example, a mobile mattress sensor system is described for use within a retail mattress store. The mobile mattress sensor system may include a pressure sensing pad that is removably placed over or fitted to a mattress and a computing device for receiving signals from the pressure sensing pad and causing the display of a body map. In one example, the pressure sensing pad includes a pressure sensing pad for measuring pressures (e.g., via an array of sensors included with the pad) of a user lying on the sensing pad. The computing device is operable to receive signals from the pressure sensing pad and cause the display of a body map of a user lying thereon. For example, the body map may graphically illustrate a body contact profile, weight distribution on the particular mattress, and so on, which may aid in selecting a suitable mattress.

Pressure body maps are generally unique to both the user and the mattress such that it is generally advantageous to perform a body map on multiple mattresses being considered for purchase. Accordingly, the mobile mattress sensor provides the benefit of allowing a user to easily move through a store and generate body pressure maps on different mattresses, thereby providing an improved manner for testing and selecting a mattress. Further, the computing device may further be operable to recommend a particular mattress brand or style based, at least in part, on the received signals and/or generated body map.

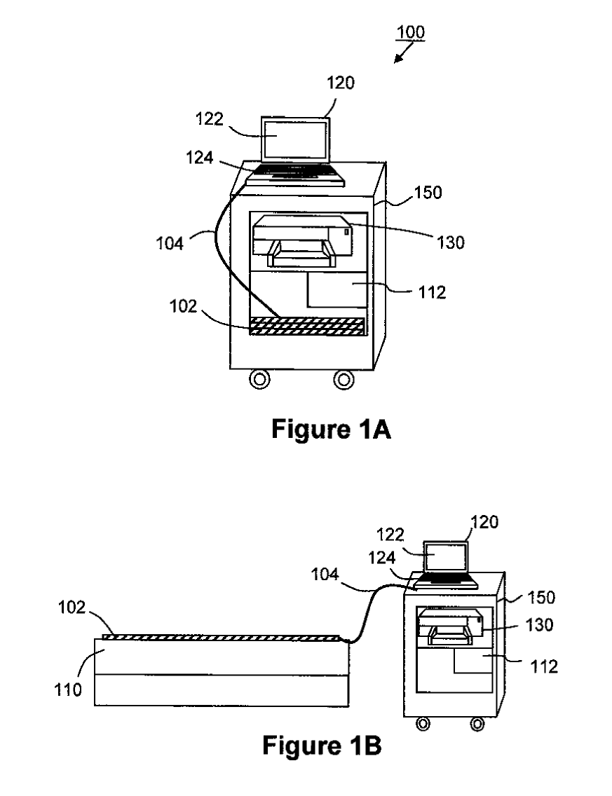

FIG. 1A illustrates an exemplary mobile mattress sensor system 100 and FIG. 1B illustrates exemplary mobile mattress sensor system 100 in use, e.g., for body mapping a user and testing a mattress 102. Generally, mobile mattress sensor system 100 includes a pressure sensing pad 110 for sensing the pressure of a person lying thereon, a computing device 120 for processing signals from pressure sensing pad 110 and causing a body map to be displayed, and a cart 150 for transporting the pressure sensing pad 110 and computing device 120.

In one example, pressure sensing pad 110 is a thin flexible pad for lying over a mattress 102 (as illustrated in FIG. 1B) and having an area of approximately 2 feet by 6 feet. The size of pressure sensing pad 110 may be generally suited for generating a body map or image of the pressure of a user (not shown) while lying on mattress 102; however, it will be appreciated that other sizes are possible, as well as the use of multiple pressure sensing pads.

Pressure sensing pad 110 may include an array of capacitance sensors; for example, including a compressible dielectric layer separating a matrix of electrical contacts forming an array of capacitors, wherein the capacitance measured across corresponding electrical contacts of a sensor varies as the dielectric layer is compressed under pressure from an overlying body. It will be appreciated that pressure sensing pad 110 may include other types or arrangements of components for sensing pressure or force of a user lying thereon, e.g., piezoelectric sensors, gas pressure sensors, electrical contact sensors, and the like, suitable for sensing pressure (and thus mapping body pressures as described).

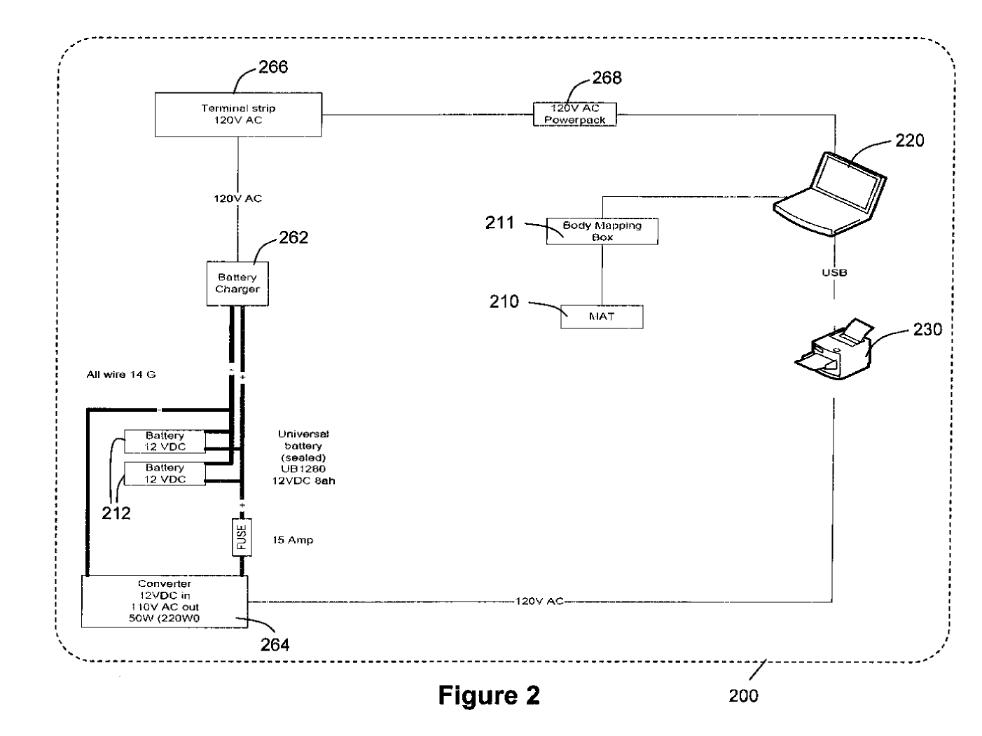

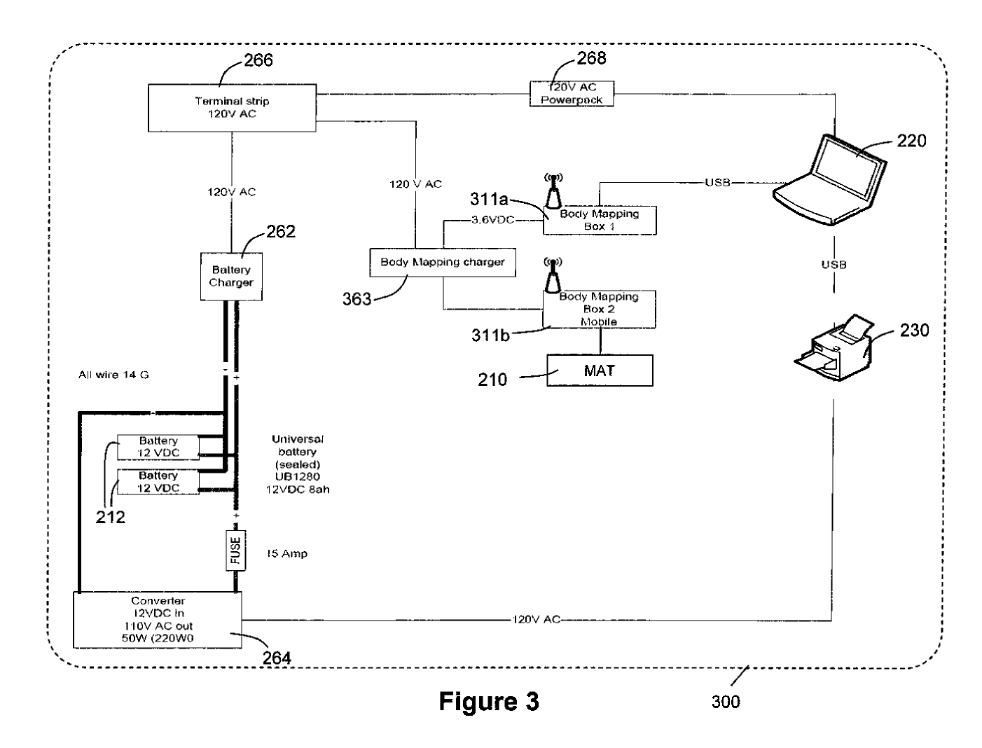

Pressure sensing pad 110 may further include or be connected to an interface unit (see, e.g., FIGS. 2 and 3) for supplying electrical driving signals to the array of sensors included with pressure sensing pad 110 and receiving signals from the array of sensors. The interface unit and/or computing device 120 may process the signals received from pressure sensing pad 110 and cause a display to be generated that graphically illustrates the distribution of weight of the user over the pressure sensing pad 110. In other examples, driving signals may be supplied directly by computing device 120.

In one example, a suitable pressure sensing pad includes a capacitive pressure imaging device such as the X3 PX100:48.144.02 bed sensor available from XSENSOR Technology Corporation. It will be appreciated, however, that various other bed sensors and pressure sensing technologies, as well as appropriate software and/or hardware (e.g., included with an interface unit and/or computing device), may be used.

Computing device 120 may include any one of various types of computer devices, having, e.g., a processing unit and a memory, as well as other conventional computer components (e.g., input device, such as a keyboard 124 and mouse, output device, such as display 122). For example, computing device 120 may include a desktop computer, laptop computer, handheld computing device, dedicated computing device, and the like.

In one example, computing device 120 further includes logic (e.g., software, firmware, and/or hardware) for causing a graphical display of a body pressure map based on received signals from pressure sensing pad 110. In other examples, computing device 120 may receive signals from a computing device (not shown in FIG. 1, but see, e.g., interface unit 211 shown in FIGS. 2 and 3) associated with pressure sensing pad 110, e.g., which generates pressure data and/or pressure maps, for use by computing device 120 for display to a user. For example, it will be appreciated that pressure sensing pad 110 may include a two-dimensional array of sensors, which generate signals that may be processed and used by computing device 120 to generate and display various graphs or maps associated with the pressures generated when a user lies on pressure sensing pad 110. In particular, a body map showing areas of relatively high and/or low pressure regions associated with the user's body, which may be displayed with varying colors etc., may guide or assist a user in selecting a particular mattress.

Computing device 120 may further be in communication with a network or remote database (e.g., via a wireless network). For example, computing device 120 may access remotely stored information regarding user information, mattress information, mattress recommendations, sales information, and the like.

Power supply 112 provides power to computing device 120 and/or pressure sensing pad 110. In one example, power supply 112 is connected to computing device 120 to provide power thereto, and pressure sensing pad 110 is connected to computing device 120, drawing power, as needed, from computing device 120. In other examples, power supply 112 may be directly connected to computing device 120 and pressure sensing pad 110 (or at least hardware such as an interface unit associated with pressure sensing pad 110). In yet another example, separate power supplies for computing device 120 and pressure sensing pad 110 may be included; for example, power supply 112 powering pressure sensing pad 110 and a local power supply with computing device 120 providing power thereto (e.g., a laptop power supply). Power supply 112 may include a rechargeable power supply in one example, which may be recharged when not in use, for example.

In one example, cart 150 is generally designed to support pressure sensing pad 110 (when not placed with a mattress), power supply 112, and computing device 120 for transportation, thereby making system 100 mobile within a retail store. For example, cart 150 may be user operated and moved within a store from mattress-to-mattress to determine body pressure maps on different mattresses. Accordingly, cart 150 may be implemented in various fashions, e.g., as a table having a height suitable for use while sitting or standing. In other examples, however, cart 150 may be implemented as a pull-cart, e.g., with only two wheels. In yet other examples, cart 150 may be implemented without wheels as a structure for supporting and transporting pressure sensing pad 110, computing device 120, and power supply 112.

Mobile mattress sensor system 100 may further include a printer 130, which may be for printing body pressure maps, pressure data, mattress recommendations, sales information, and the like. Computing device 120 may communicate with printer 130 via a USB cable or other wired or wireless connection. Additionally or alternatively, in other examples, computer device 120 may communicate, e.g., via a wireless network, to a remote printer not included with mobile mattress sensor system 100.

FIG. 2 schematically illustrates components of an exemplary mobile mattress sensor system 200 according to one example. In this example, mobile mattress sensor system 200 includes a pressure sensing pad 210, computing device 220, and printer 230 similar or identical to those described above. Additionally, this figure illustrates that the system includes a body mapping interface unit 211 disposed between pressure sensing pad 210 and computing device 220. Body mapping interface unit 211 may include suitable logic (e.g., hardware or software) for sending driving signals (if needed) to pressure sensing pad 210 and/or receiving signals from sensors associated with pressure sensing pad 210. In some examples, body mapping interface unit 211 processes the received signals for causing the generation of a body map, the processed data communicated to computing device 220 for display, manipulation, printing, and the like.

Body mapping interface unit 211 and/or pressure sensing pad 210 may be connected to computing device 220 via a USB cable, for example (or as detailed below, may communicate wirelessly). In other examples, pressure sensing pad 210 may connect directly to computer 220, without the need of body mapping interface unit 211 (where computing device 220 provides driving signals, if needed, and receives signal directly from pressure sensing pad 210).

In this example, power source 212 includes two 12 Volt rechargeable batteries, connected in parallel to a converter 264 for providing 110V AC power to devices associated with mobile mattress sensor system 200. For instance, in one example, providing power to a terminal strip 266, for which computing device 220 via power pack 268 may be connected. Additionally, printer 230 and/or body pad 210/body mapping interface unit 211 may be connected to receive power from power source 212, e.g., via terminal strip 266. In other examples, one or more of the associated devices may be connected directly to power source 212.

Additionally, a battery charger 262 is included for recharging power source 212. In one example, battery charger 262 may operate to plug into a conventional wall outlet, e.g., at 110V AC, and converted accordingly to charge the batteries of power source 212. It will be appreciated that various other batteries, converters, chargers, and so on are possible, and further that in some examples, rechargeable batteries of power source 212 may be removed from the mobile mapping system 200 for charging with a remote battery charger (not shown).

FIG. 3 schematically illustrates an exemplary mobile mattress sensor system 300 according to another example. System 300 is similar to that of system 200 discussed above; accordingly, only differences will be discussed in detail. In this example, a first body mapping interface unit 311a is connected to computing device 220 and a second body mapping interface unit 311b is connected to a pressure sensing pad 210. In this example, body mapping interface unit 311b and/or pressure sensing pad 210 may communicate wirelessly and may be removed from the system for placement with a mattress. In particular, signals from pressure sensing pad 210 are communicated by body mapping interface unit 311b to body mapping interface unit 311a via a wireless signal (e.g., an RF signal) and communicated to computing device 220 for processing and/or display as previously described by body mapping interface 311a. In other examples, signals from pressure sensing pad 210 may be communicated directly to computing device 220 wirelessly, e.g., via RF signals, a Wi-Fi connection, or the like. Further, in this example, charger 363 is included for charging body mapping interface unit 311b and/or pad sensor 210.

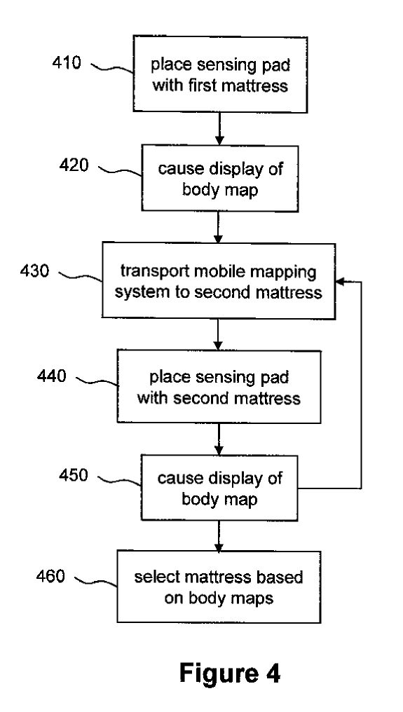

FIG. 4 illustrates an exemplary method for generating map profiles and testing/selecting mattresses using a mobile body mapping system as described. In one example, the method initially includes placing a pressure sensing pad on or over a first mattress and having a user lie down at 410. The computing device then receives signals from the sensing pad, which may include causing or providing driving signals to the sensing pad, and causes a body map to be displayed based on the received signals at 420.

After a body map has been generated the pressure sensing pad may be removed from the first mattress and the mobile sensing system may be transported to a second mattress at 430. The pressure sensing pad may then be placed on or over the second mattress for the user to again lie down at 440. The computing device then receives signals from the sensing pad, which may include causing or providing driving signals to the sensing pad, and causes a second body map to be displayed based on the received signals at 450. A user may then make a determination or selection of a mattress based on the body mapping at 460. Additionally, a user may repeat 430 and 440 as indicated by the arrow to transport the body mapping system to any number of mattresses for additional body mapping.

The foregoing descriptions of specific examples and embodiments have been presented for purposes of illustration and description. They are not intended to be exhaustive, and it should be understood that many modifications and variations are possible in light of the above teaching. Additionally, particular examples have been discussed and how these examples are thought to address certain disadvantages in related art. This discussion is not meant, however, to restrict the various examples to methods and/or systems that actually address or solve the disadvantages.

We claim:

1. A mobile body mapping system for testing mattresses, the mobile body mapping system, comprising:
a pressure sensing pad;
a computer device and associated display operable to receive signals from the pressure sensing pad and cause the display a body map associated with the received signals;
a power source for powering the computer device; and
a cart for transporting the pressure sensing pad, computer device, and power source.

2. The mobile body mapping system of claim 1, wherein the pressure sensing pad comprises a flexible pressure sensing pad for removably disposing with a mattress.

3. The mobile body mapping system of claim 1, wherein the computer device comprises logic operable to cause the display of a body map based on the received signals.

4. The mobile body mapping system of claim 1, further comprising an interface unit for sending driving signals to, and receiving signals from, the pressure sensing pad, wherein the interface unit is connectable to the computing device.

5. The mobile body mapping system of claim 1, wherein the cart further comprising a printer connected to the computer device.

6. The mobile body mapping system of claim 1, wherein the power source comprises a rechargeable battery.

7. The mobile body mapping system of claim 1, wherein the power source comprises a rechargeable battery included with the computing device.

8. The mobile body mapping system of claim 1, wherein the cart comprises wheels.

9. A mobile body mapping system for testing mattresses, the mobile body mapping system comprising:
a display;
a computer device operable to receive signals from a pressure sensing pad and cause a display associated with the received signals on the display;
a power supply for powering the computer device; and
a cart for supporting and transporting the computer device and display.

10. The mobile mattress sensor system of claim 9, further comprising a pressure sensing pad.

11. The mobile body mapping system of claim 9, wherein the computer device comprises logic operable to cause the display of a body map based on the received signals.

12. The mobile body mapping system of claim 9, further comprising an interface unit for sending driving signals to, and receiving signals from, the pressure sensing pad, wherein the interface unit is connected to the computing device.

13. The mobile body mapping system of claim 9, wherein the cart further comprising a printer connected to the computer device.

14. The mobile body mapping system of claim 9, wherein the power source comprises a rechargeable battery.

15. The mobile body mapping system of claim 9, wherein the cart comprises wheels.

16. A method for body mapping users on a mattress with pressure sensing pad, the method comprising:
placing a pressure sensing pad over a first mattress;
receiving signals from the pressure sensing pad at a computing device, wherein the computing device is included with a mobile body mapping apparatus, the apparatus comprising a cart for supporting the computing device, the pressure sensing pad, and a power supply for powering the computing device during transportation; and
causing the display of an image based on the received signals.

17. The method of claim 16, further comprising transporting the cart to a second mattress, placing the pressure sensing pad over the second mattress, and receiving signals form the pressure sensing pad.
